(19) United States
(12) Patent Application Publication
(10) Pub. No.: US 2009/0108116 A1
(43) Pub. Date: Apr. 30, 2009

(54) Winding Wheel Set for a Curtain

(76) Inventor: Tso-Shu CHANG, Taichung City (TW)

Correspondence Address: Dr. BANGER SHIA, 102 Lindencrest Ct., Sugar Land, TX, 77479-5201, US

(21) Appl. No.: 11/923,646

(22) Filed: Oct. 24, 2007

(51) Int. Cl. B65H 75/34; E06B 9/322

(52) U.S. Cl. 242/388; 160/309

(57) ABSTRACT

A winding wheel set for a curtain comprises a base and a roller, wherein the roller is rotatablely disposed on the base, in the base is formed an elongated slot for insertion of a string, thus making the string be wound on the roller comfortably, so as to prevent the former problem that the string is hard to be pulled because of the big bend. Additionally, on the roller are disposed two blocks for cooperating with the roller, so as to limit the string to be wound on the start position of the roller.

### BACKGROUND OF THE INVENTION

1. Field of the Invention

The present invention relates to a curtain, and more particularly to a winding wheel set for a curtain.

2. Description of the Prior Art

The well-known curtain can control the opening and closing of the curtain by controlling the extension string of the inner winding wheel set. Referring to FIGS. 1 and 2, the common winding wheel set comprises a base 10 and a roller 20. A round hole 11 is formed at one end of the base 10. The roller 20 is rotatablely disposed on the base 10, and a plurality of axially extending ribs 21 is disposed around the outer surface of the roller 20. A tapering portion 22 is formed at one end of the base 10 and located adjacent the through hole 11. The roller 20 is tapered from one end where the tapering portion 22 is located to the other end, so as to reduce the cross sectional area of the roller 20 from the end where the tapering portion 22 is formed to the other end. The tapering gradient of the tapering portion 22 is greater than that of other parts of the roller 20.

FIG. 3 shows the using of the winding wheel set. A string A is inserted into the hole 11 of the base 10 and wound on the roller 20 from the tapering portion 22 to the other end. The tapering portion 22 can limit the winding direction of the string A and can prevent the string A from leaving the roller 20 from the tapering portion 22. Referring to FIG. 4, in practice, the tapering gradient of the tapering portion 22 of the roller 20 is greater than that of other parts of the roller 20, thereby partial string A wound on the tapering portion 22 will slide to the other end of the roller 20 because of gravity, and finally overlap at the end of the roller where the tapering portion 22 is located, thereby the operation is uncomfortable, even it will cause knotting of the string A.

When the roller 20 is pivotally disposed on the base 10, the space therebetween will be small enough, so as to save the space. Therefore, referring to FIG. 5, when the string A is inserted into the hole 11 of the base 10, the string A will be bent nearly to a vertical position, this will make it uncomfortable to pull the string A, and the string A is likely to be broken because of a long-term friction.

The present invention has arisen to mitigate and/or obviate the afore-described disadvantages.

### SUMMARY OF THE INVENTION

The primary objective of the present invention is to provide a winding wheel set, so as to make the operation be comfortable and the string not easily overlap.

The secondary objective of the present invention is to provide a winding wheel set, so as to make the operation be comfortable and the string not easily be separated.

In order to achieve the abovementioned objectives, the winding wheel set comprises a base and a roller, wherein the roller is rotatablely disposed on the base, two opposite blocks are located on both sides of the base, a slot is formed in the base, the roller is tapered from the one end to the other end, so as to reduce the cross sectional area of the roller from one end to the other end equally, and the end of the roller with a large cross sectional area abuts against the first end of the base.

Therefore, when the string is inserted into the slot of the base, the string is limited by the two blocks, so that it is prevented from disengaging the roller from the end with a larger cross sectional area. Meanwhile, the string is limited by the two blocks and sequentially wound on the roller from the end with a large cross sectional area to the other end. The cross sectional area of the roller tapers equally, so that the string will not overlap and the operation will be comfortable.

Additionally, the slot of the base is elongated, and the extension direction of the slot is intersected to the axial direction of the roller. When the string is inserted into the slot, the position of the string can be adjusted in the slot, thus the string can be wound on the roller comfortably. Further, the extension direction of the slot is vertical to the axial direction of the roller, so as to achieve the best effect.

### BRIEF DESCRIPTION OF THE DRAWINGS

FIG. 1 is an exploded view of a conventional winding wheel set;

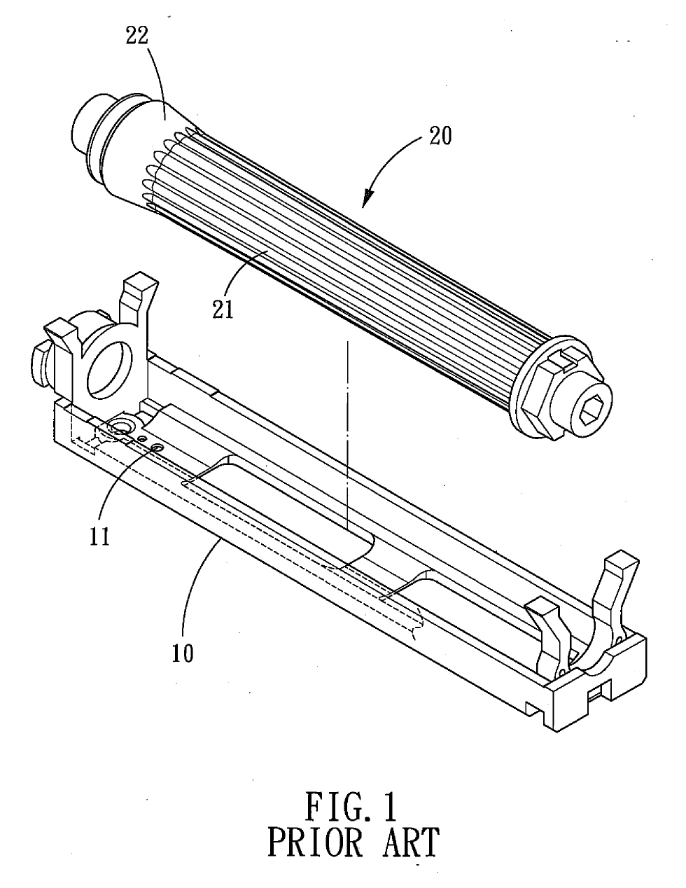

FIG. 2 is a perspective view of a conventional winding wheel set;

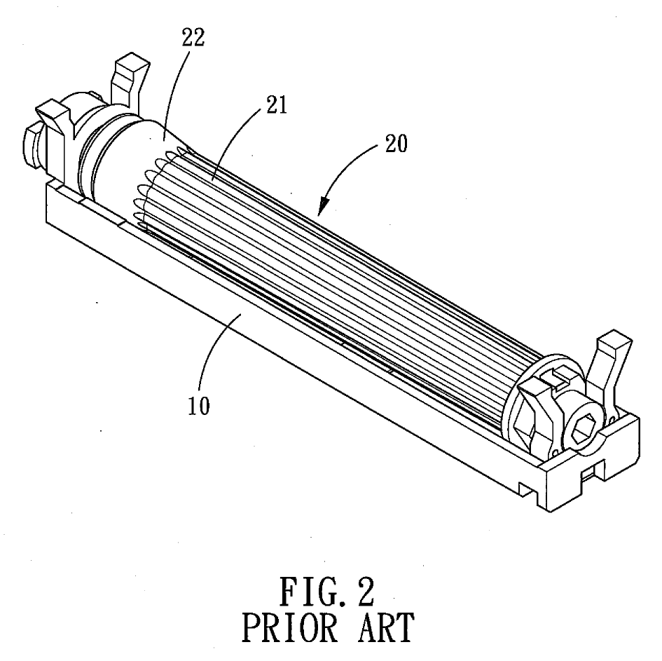

FIG. 3 is an illustrative view showing the winding operation of a string on the conventional winding wheel set;

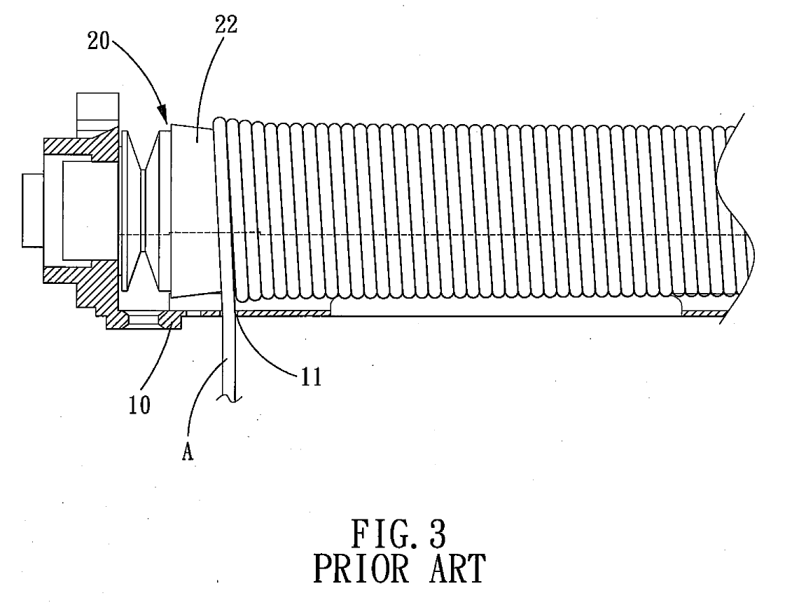

FIG. 4 is an illustrative view showing the string overlapping problem of the conventional winding wheel set;

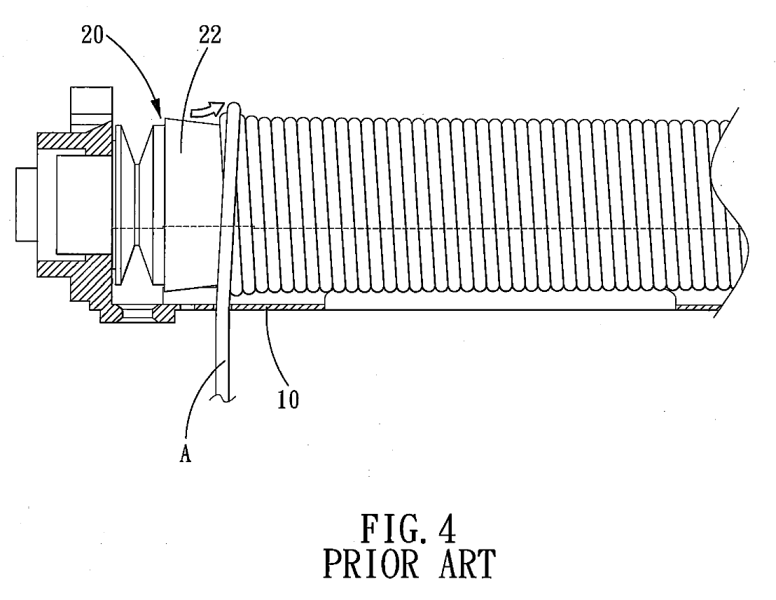

FIG. 5 is an illustrative view showing the string wound on the conventional winding wheel set being inserted into the slot;

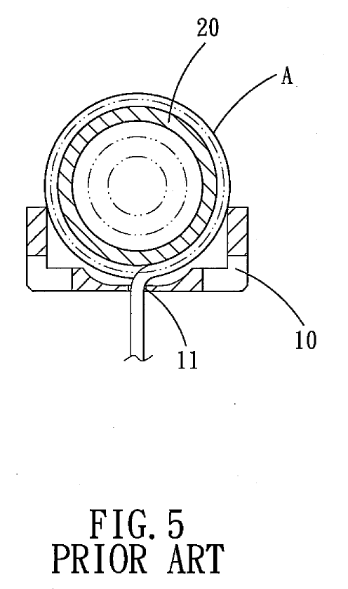

FIG. 6 is an exploded view of a winding wheel set for a curtain in accordance with the embodiment of the present invention;

FIG. 7 is a perspective view of the winding wheel set for a curtain in accordance with the embodiment of the present invention;

FIG. 8 is an illustrative view showing the winding operation of a string on the winding wheel set in accordance with the embodiment of the present invention; and

FIG. 9 is an illustrative view showing the string wound on the winding wheel set being inserted into the slot in accordance with the embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

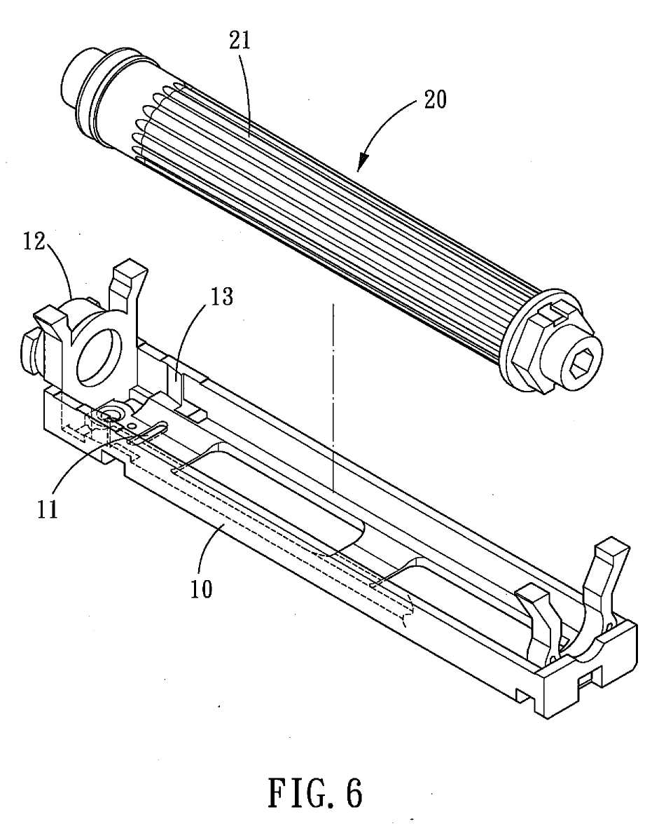

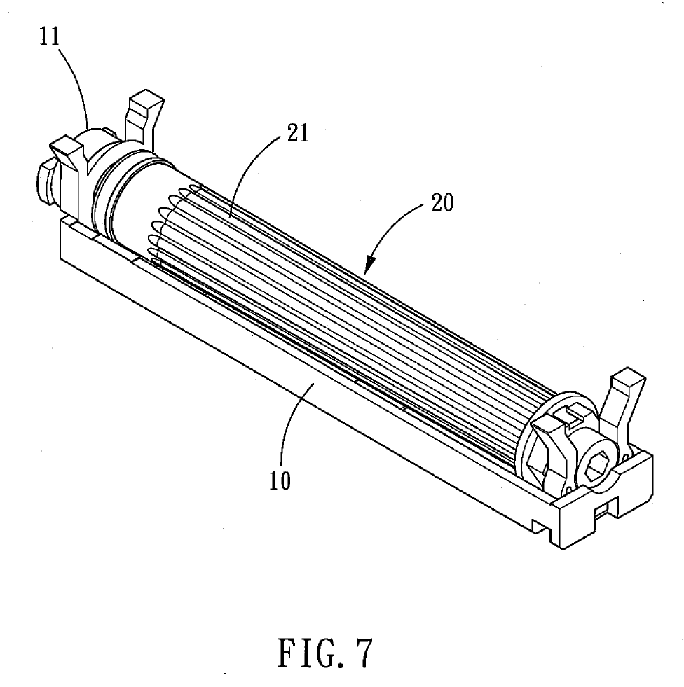

Referring to FIGS. 6 and 7, a winding wheel set for a curtain in accordance with the present invention is shown and comprises a base 10 and a roller 20 rotatablely disposed thereon. The structure and method of how the roller 20 is pivotally disposed on the base 10 are not the features of the present invention but a conventional art, so it won't be described hereon. The base 10 and the roller 20 are described separately.

The base 10 is elongated and has two opposite blocks 13 located at both sides of the first end 12 of the base 10. An elongated slot 11 formed in the base 10 is arranged between the two blocks 13. The two blocks 13 are nearer the first end 12 of the base 10 than the slot 11. The extension direction of the slot 11 is vertical to the axial direction of the roller 20.

The roller 20 is formed on its outer surface with a plurality of axially extending ribs 21. The roller 20 is tapered from one end to the other end, so as to reduce the cross sectional area of the roller 20 from one end to the other end equally. The end of the roller 20 with a larger cross sectional area abuts against the first end 12 of the base 10.

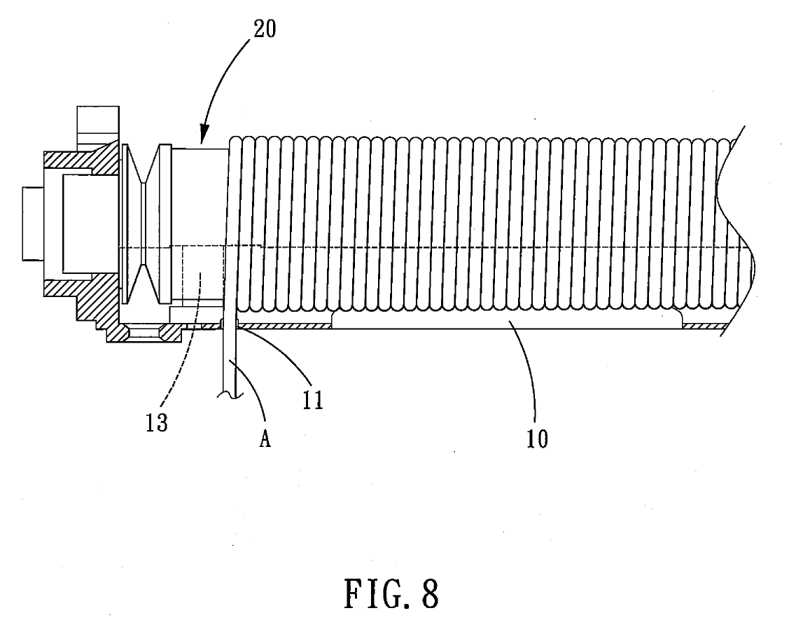

FIG. 8 shows the using of the winding wheel set. A string A is inserted into the slot 11 of the base 10 and wound on the roller 20 from the larger end to the smaller end. The string A is limited by the two blocks 13 of the base 10, so that it is prevented from disengaging the roller 20 from the end with a larger cross sectional area. Additionally, the cross sectional area of the roller 20 tapers equally, so that the string A will not overlap and the operation will be comfortable.

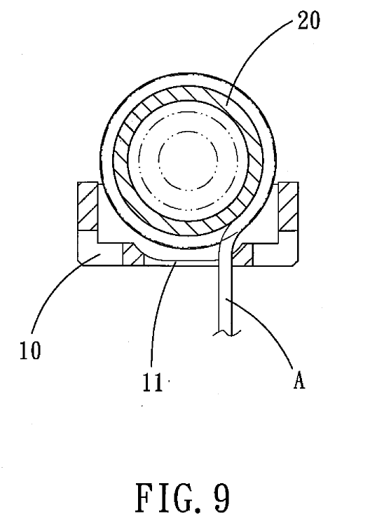

When the string A is inserted into the slot 11 of the base 10 and then wound on the roller 20, referring to FIG. 9, the extension direction of the slot 11 is vertical to the axial direction of the roller 20, thereby the position of the string A can be adjusted in the slot 11 and the string can be wound on the roller 20 comfortably. The operation of the string A will also be comfortable, and the friction between the string A and the base 10 can be reduced, so as to prolong the life of the string A.

While we have shown and described various embodiments in accordance with the present invention, it is clear to those skilled in the art that further embodiments may be made without departing -from the scope of the present invention.

What is claimed is:

1. A winding wheel set for a curtain comprising:
a base having two opposite blocks located at both sides of one end of the base, a slot being defined in the base and located between the two blocks for insertion of a string, and the two blocks being nearer the said end than the slot; and
a roller being rotatablely disposed on the base, the roller being tapered from one end to the other end, so as to reduce a cross sectional area of the roller from one end to the other end equally, and the end of the roller with a large cross sectional area abutting against the said end of the base.

2. The winding wheel set for a curtain as claimed in claim 1, wherein the slot is elongated, and an extension direction of the slot is intersected with an axial direction of the roller.

3. The winding wheel set for a curtain as claimed in claim 2, wherein the extension direction of the slot is vertical to the axial direction of the roller.
